(19) United States
(12) Patent Application Publication
(10) Pub. No.: US 2026/0288584 A1
(43) Pub. Date: Sep. 24, 2026

(54) DIE REBUILD OPERATIONS FOR IMPROVED ACCESS PERFORMANCE IN A MEMORY SYSTEM

(71) Applicant: Micron Technology, Inc., Boise, ID (US)

(72) Inventors: Naveen Bolisetty, Suryapet (IN); James P. Crowley, Longmont, CO (US)

(21) Appl. No.: 19/569,951

(22) Filed: Mar. 17, 2026

Related U.S. Application Data
(60) Provisional application No. 63/775,894, filed on Mar. 21, 2025.

(51) Int. Cl. G06F 11/10

(52) U.S. Cl. CPC G06F 11/108; G06F 11/1088

(57) ABSTRACT

Methods, systems, and devices for die rebuild operations for improved access performance in a memory system are described. A memory system may select a fold rate based on an amount of valid data in the memory system to balance a speed at which the fold operations are performed with a capacity for the memory system to perform other access operations while performing the fold operations. For example, after detecting a die failure, the memory system may recover data stored to one or more first block stripes. The memory system may transfer the recovered data from the first block stripes to second block stripes within the memory system according to a fold rate that is based on an amount of valid data included in the memory system. By selecting a fold rate dynamically, the memory system may perform operations to access other stored data in parallel with performing the fold operations.

### CROSS REFERENCE

The present Application for Patent claims priority to U.S. Patent Application No. 63/775,894 by Bolisetty et al., entitled “DIE REBUILD OPERATIONS FOR IMPROVED ACCESS PERFORMANCE IN A MEMORY SYSTEM,” filed Mar. 21, 2025, which is assigned to the assignee hereof, and which is expressly incorporated by reference in its entirety herein.

### TECHNICAL FIELD

The following relates to one or more systems for memory, including die rebuild operations for improved access performance in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports die rebuild operations for improved access performance in a memory system in accordance with examples as disclosed herein.

FIG. 2 shows an example of an architecture that supports die rebuild operations for improved access performance in a memory system in accordance with examples as disclosed herein.

FIG. 3 shows an example of a process that supports die rebuild operations for improved access performance in a memory system in accordance with examples as disclosed herein.

FIG. 4 shows a block diagram of a memory system that supports die rebuild operations for improved access performance in a memory system in accordance with examples as disclosed herein.

FIG. 5 shows a flowchart illustrating a method or methods that support die rebuild operations for improved access performance in a memory system in accordance with examples as disclosed herein.

### DETAILED DESCRIPTION

Some memory systems may include multiple memory dies (e.g., multiple logical unit numbers (LUNs)) that may eventually fail over time and use. A memory system may be able to recover data from and continue operations associated with failed memory dies if the quantity of failed memory dies does not exceed a threshold quantity of failed memory dies. For example, the memory system may support a single die data correction (SDDC) scheme or a double die data correction (DDDC) scheme, or some other die correction scheme associated with a threshold quantity of memory dies that may be repaired and recovered at one time. The recovery of erred data within the dies may be performed using one or more codewords across the dies and a data recovery technique, such as a redundant array of independent not-and (NAND) (RAIN) recovery operation or other data recovery techniques to recover erred data. Additionally, or alternatively, the memory system may fold valid data from sets of memory blocks (e.g., memory block stripes) included in the failed memory die(s) to new memory block stripes. The folding operation may include recovering failed portions of the data using the data recovery techniques and transferring the recovered data to the new memory block stripes.

While fold operations may support recovery, by the memory system, of data from failing memory dies, performing relatively large quantities of fold operations within a given period of operation of the memory system may decrease efficiency and performance of the memory system. For example, if the memory system determines that multiple sets of memory block stripes require folding in order to save stored, valid data, the memory system may perform a relatively large quantity of fold operations. However, while performing a large quantity of fold operations, the memory system may not perform operations associated with other incoming access commands, which may increase latency and reduce performance, among other examples. Techniques for reducing the effects of latency and overhead associated with fold operations may be beneficial.

As described herein, a memory system may dynamically select a fold rate based on an amount of valid data in the memory system when performing fold operations in order to balance a speed at which the fold operations are performed with the capacity for the memory system to perform other access operations while folding. For example, the memory system may store mapping information that maps percentages of valid data (e.g., percentages of data, from among all data stored to memory dies within the memory system, that is valid) to respective candidate fold rates. The memory system may select one of the fold rates based on the mapping information and a percentage of valid data in the memory system, and may transfer the data from a first memory block stripe associated with one or more failed memory dies to one or more other memory block stripes according to the selected fold rate. Valid data may refer to data that is to be saved during fold operations and is not to be erased, such as data that does not include errors, includes less than a threshold quantity of errors, that is not stored to a failed memory die, or any combination thereof. The fold rate may be an amount of data that may be transferred within a given duration (e.g., 200 megabytes of data transferred per second, or two block stripes per hour, or some other rate). In some examples, the fold rate may be less than a maximum fold rate supported by the memory system, such that the memory system may support operations to access data stored to one or more other block stripes (e.g., in response to various received access commands) during the same duration in which the memory system performs the fold operations. The maximum fold rate supported by the memory system may be a rate at which the memory system is continuously performing fold operations within a duration and is unable to execute other functions, such as access operations within the duration. Accordingly, a lower fold rate may provide for the memory system to pause the folding intermittently and perform other operations. For example, the memory system may fold a first portion of data, pause to read or write to other data within the memory system, and then resume folding a remaining portion of the data, and may still successfully fold sufficient data within a given duration to satisfy the fold rate. Thus, if the memory system has less valid data to fold, the memory system may slow fold operations and prioritize other access, which may decrease latency and improve performance. Use of a dynamic fold rate may thereby increase performance at the memory system while decreasing data loss by increasing balance between access operations and error correction operations.

In addition to applicability in memory systems as described herein, techniques for die rebuild operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, techniques for die rebuild operations may be generally implemented to improve the sustainability of various electronic devices and systems. As the use of electronic devices has become even more widespread, the amount of energy used and harmful emissions associated with production of electronic devices and device operations has increased. Further, the amount of waste (e.g., electronic waste) associated with disposal of electronic devices may also pose environmental concerns. Implementing the techniques described herein may improve the impact related to electronic devices by improving die rebuild operations, which may extend the life of electronic devices and thereby reducing electronic waste, among other benefits.

Features of the disclosure are illustrated and described in the context of systems, devices, and circuits. Features of the disclosure are further illustrated and described in the context of architectures, processes, and flowcharts.

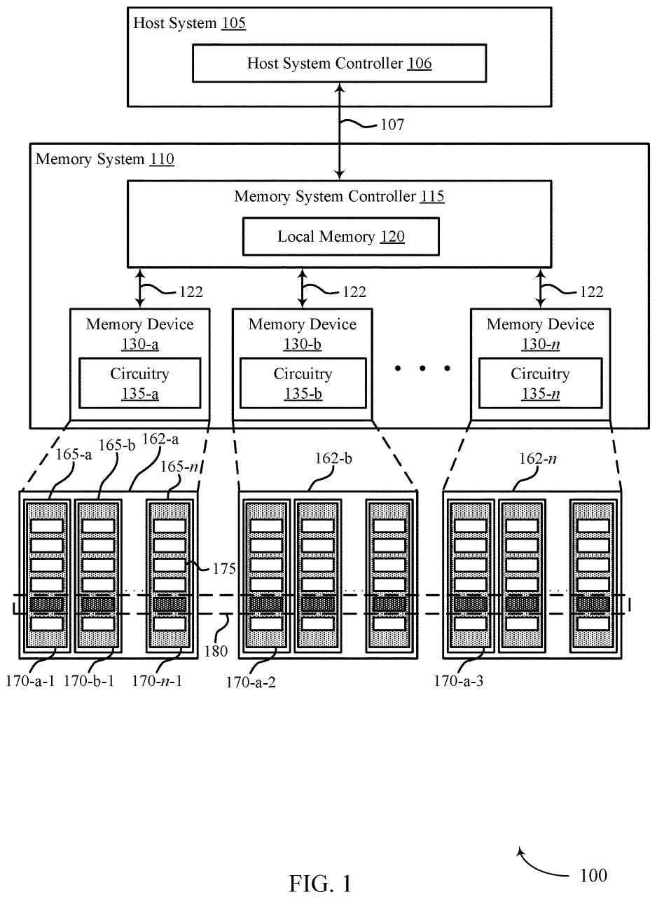

FIG. 1 shows an example of a system 100 that supports die rebuild operations for improved access performance in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-n, where n represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-n may include circuitry 135-n.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include n planes 165 and each plane may include m blocks 170, where n and m represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-n, where n represents an Nth plane. The memory die 162-b and the memory die 162-n may also include N planes. In some cases, an individual block 170 may be referred to as a physical block, and a virtual block 180 may refer to a group of physical blocks 170 within which concurrent operations may occur. A virtual block 180 may be a logical structure that includes a plurality of blocks, where different blocks of the plurality of blocks may come from different planes 165 or different memory dies 162. In some cases, a virtual block may include blocks 170 from different memory devices 130 (e.g., including blocks in one or more planes 165 of memory device 130-a, memory device 130-b, and memory device 130-n). In some examples, a virtual block may include a respective block from each plane 165 (e.g., a block 170 from each plane 165) of one or more memory dies 162.

In some cases, the blocks 170 within a virtual block may have the same block address within their respective planes 165. For example, block 170-a-1 may be “block 0” of a first plane of die 162-a, block 170-a-2 may be “block 0” of a first plane of die 162-b, block 170-a-3 may be “block 0” of a first plane of die 162-n, and so on. By way of further example, block 170-b-1 may be “block 1” of a first plane of die 162-a and block 170-n-1 may be “block n” of die 162-a, where n represents an Nth block. The memory die 162-b and the memory die 162-n may also include N blocks. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In some cases, to update some data within a block 170 while retaining other data within the block 170, the memory device 130 may write the updated data to a new block 170. The memory device 130 (e.g., circuitry 135) or the memory system controller 115 may mark or otherwise designate the addresses of the data that was updated in the block 170 as invalid or obsolete and may update a logical-to-physical (L2P) mapping table to associate the logical address (e.g., LBA) for the data with the new block 170 rather than the original block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by circuitry 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or circuitry 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some examples, the memory devices 130 (e.g., LUNs, memory dies) may eventually fail over time due to use (e.g., access operations at the memory devices 130). The memory system controller 115 may be able to recover data from and continue operations associated with failed memory devices 130 if the quantity of failed memory devices 130 does not exceed a threshold quantity of failed memory devices 130. For example, the memory system controller 115 may support an SDDC scheme or a DDDC scheme, or some other die correction scheme associated with a threshold quantity of memory dies that may be repaired and recovered at one time. The recovery of erred data within the dies may be performed using one or more codewords across the dies and a data recovery technique, such as a RAIN recovery operations or other data recovery techniques to recover erred data from the memory devices 130 that may be failing. Additionally, or alternatively, the memory system controller 115 may fold valid data from sets of blocks 170 (e.g., memory block stripes) included in the failing memory device(s) 130 to new memory block stripes. The folding operation may include recovering failed portions of the data using the data recovery techniques and transferring the recovered data to the new memory block stripes.

While fold operations may support recovery, by the memory system controller 115, of data from memory devices 130 that may be failing, performing relatively large quantities of fold operations within a given period of operation of the memory system may decrease efficiency and performance of the memory system controller 115. For example, if the memory system controller 115 determines that multiple sets of memory block stripes require folding in order to save stored, valid data, the memory system controller 115 may perform a relatively large quantity of fold operations. However, while performing a large quantity of fold operations, the memory system controller 115 may not perform operations associated with other incoming access commands, which may increase latency and reduce performance, among other examples. Techniques for reducing the effects of latency and overhead associated with fold operations may be beneficial.

As described herein, the memory system controller 115 may dynamically select a fold rate based on an amount of valid data in the memory system 110 when performing fold operations in order to balance a speed at which the fold operations are performed with a capacity for the memory system controller 115 to perform other access operations while folding. For example, the memory system controller 115 may store mapping information that maps percentages of valid data (e.g., percentages of data, from among all data stored to memory devices 130 within the memory system 110, that is valid) to respective candidate fold rates. The memory system controller 115 may select one of the fold rates based on the mapping information and a percentage of valid data stored to the memory system controller 115, and may transfer the data from a first memory block stripe associated with one or more failed memory devices 130 to one or more memory block stripes according to the selected fold rate. Valid data may refer to data that is to be saved during fold operations and is not to be erased, such as data that does not include errors, includes less than a threshold quantity of errors, that is not stored to a failed memory die, or any combination thereof. The fold rate may be an amount of data that may be transferred within a given duration (e.g., 200 megabytes of data transferred per second, or two block stripes per hour, or some other rate). In some examples, the fold rate may be less than a maximum fold rate supported by the memory system controller 115, such that the memory system controller 115 may support operations to access data stored to one or more other block stripes (e.g., in response to various received access commands) during the same duration in which the memory system controller 115 performs the fold operations. The maximum fold rate supported by the memory system 110 may be a rate at which the memory system 110 is continuously performing fold operations within a duration and is unable to execute other functions, such as access operations within the duration. Accordingly, a lower fold rate may provide for the memory system 110 to pause the folding intermittently and perform other operations. For example, the memory system controller 115 may fold a first portion of data, pause to read or write to other data within the memory system 110, and then resume folding a remaining portion of the data, and may still successfully fold sufficient data within a given duration to satisfy the fold rate. Thus, if the memory system 110 has less valid data to fold, the memory system controller 115 may slow fold operations and prioritize other access, which may decrease latency and improve performance. Use of a dynamic fold rate may thereby increase performance at the memory system controller 115 while decreasing data loss by increasing balance between access operations and error correction operations.

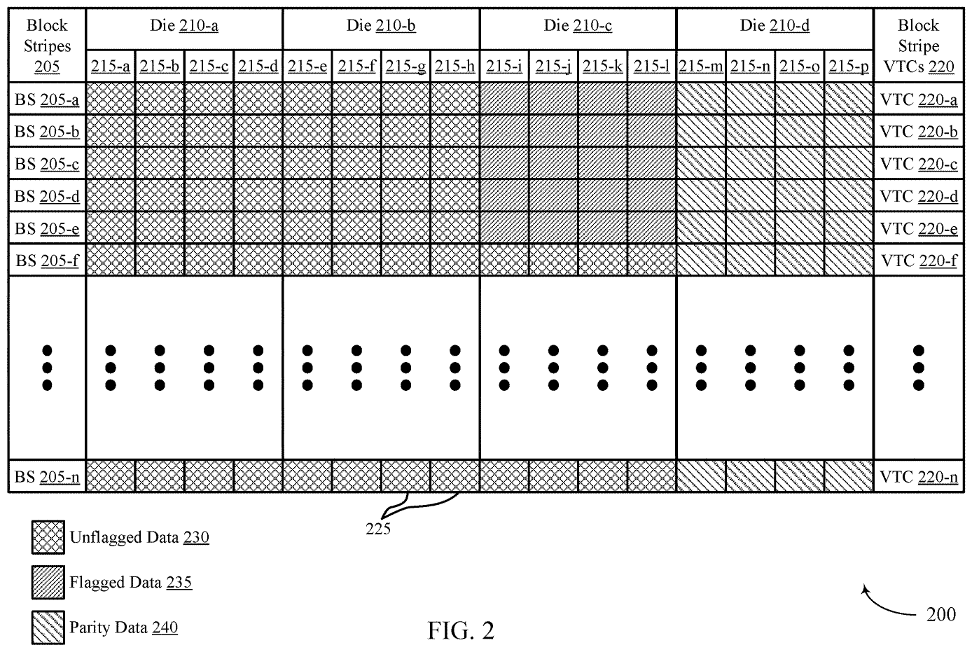

FIG. 2 shows an example of an architecture 200 that supports die rebuild operations for improved access performance in a memory system in accordance with examples as disclosed herein. The architecture 200 may include examples of a system 100 as described with reference to FIG. 1. For example, the architecture 200 illustrates a configuration for storage of data within one or more dies 210, planes 215, and blocks 225, which may be examples of memory devices 130, planes 165, and blocks 170, respectively, as described herein with reference to FIG. 1. A memory system 110, as described herein with reference to FIG. 1, may store data according to the architecture 200, and a controller of the memory system (e.g., a memory system controller 115) may be configured to perform operations at the various components thereof.

The architecture 200 may include one or more dies 210 (e.g., LUNs, memory devices), which may each include one or more planes 215 of blocks 225. For example, the die 210-a may include the plane 215-a, the plane 215-b, the plane 215-c, and the plane 215-d, which may be examples of memory devices 130 and planes 165, respectively, as described herein with reference to FIG. 1. Each of the planes 215 may include blocks 225 (e.g., sets of the blocks 225), which may each be examples of blocks 170 as described with reference to FIG. 1, and may each store data (e.g., unflagged data 230, flagged data 235, parity data 240).

Each of the dies 210-a, 210-b, 210-c, and 210-d may be associated with multiple block stripes 205 (e.g., block stripes 205-a, 205-b, 205-c, 205-d, 205-e, 205-f, through block stripe 205-n), which may each include (e.g., be associated with) a set of the blocks 225 and may span across the planes 215 of each die 210. For example, the block stripe 205-a may be associated with a first set of blocks 225 of the planes 215 of the dies 210 (e.g., the plane 215-a through plane 210-p), and the block stripe 205-b may be associated with a second set of blocks 225 of the planes 215 of the dies 210. Each of the block stripes 205 may be associated with a block stripe valid transfer unit (TU) count (VTC) 220 (e.g., VTC 220-a, 220-b, 220-c, 220-d, 220-e, 220-f, through VTC 220-n). For example, the block stripe 205-a may be associated with a VTC 220-a. Each of the VTCs 220 may indicate a quantity of the blocks 225 of the associated block stripe 205 that are not associated with an error (e.g., that include valid data, that include the unflagged data 230). In some examples, each of the block stripes 205 may be associated with a counter at the memory system controller (e.g., not illustrated).

A controller of the memory system may perform various operations to access data stored within the dies 210. For example, the memory system controller may perform access operations to access (e.g., read, program, erase) data within the blocks 225 in response to received access commands. In some examples, the dies 210 (e.g., the planes 215 and the blocks 225 thereof) may eventually experience failure over time due to the memory system controller performing relatively large quantities of access operations at the dies 210, due to time, or both. Examples of a die 210 failure may be a relatively high-quantity of failed blocks 225, an inability of the memory system controller to detect a die 210 during enumeration operations, the occurrence of a DQS timeout (e.g., a die 210 may be unresponsive), the occurrence of adjacent program failures, or any combination thereof. In some examples, the memory system controller may track a quantity of failures associated with each of the blocks 225 of the block stripes 205 using the VTCs 220. For example, the memory system controller may detect a failure at one or more of the blocks 225 of the block stripe 205-a, the block stripe 205-b, the block stripe 205-c, the block stripe 205-d, and the block stripe 205-e of the die 210-c. In response, the memory system controller may flag data stored to the blocks 225 of the block stripe 205-a through the block stripe 205-e of the die 210-c as being associated with the failing blocks 225 and thus potentially including errors. The data stored to blocks 225 within the failed die 210-c may be referred to as flagged data 235 herein (e.g., erred data, invalid data). The memory system controller may also set a value in each of the VTCs 220 associated with the block stripes 205 including the failing blocks 225 (e.g., the VTC 220-a, the VTC 220-b, the VTC 220-c, the VTC 220-d, the VTC 220-e) to indicate a quantity of valid blocks 225 included in each of the respective block stripes 205.

The memory system controller may be able to recover data from and continue operations associated with failing blocks 225 of the die 210-c. For example, the memory system controller may support RAIN recovery operations or other data recovery techniques to recover to recover the flagged data 235 from the failing blocks 225 of the die 210-c. The memory system controller may use the unflagged data 230 and the parity data 240 of each block stripe 205 to re-generate the flagged data 235 of each respective block stripe 205 associated with a VTC 220 that indicates that the respective block stripe 205 includes a quantity of valid blocks 225. After recovering the flagged data 235, the memory system controller may fold (e.g., transfer, copy) the recovered data and the unflagged data 230 from each block 225 of the block stripes 205 associated with the VTCs 220 including a value indicating a quantity of valid blocks 225 to other block stripes 205 that may not be associated with or include failing blocks 225.

While performing data recovery and fold operations may allow the memory system to recover flagged data 235 from and continue to use block stripes 205 (e.g., data and parity data stored to blocks 225 thereof) that may be at least partially included in a failed die 210, performing large quantities of these operations may decrease efficiency and performance of the memory system. For example, the memory system controller may perform data recovery and fold operations on the block stripes 205 according to a relatively high fold rate, in some examples, in order to complete the fold as quickly as possible. However, the memory system controller may not be able to perform other operations until the folding at the relatively high fold rate is complete, which may increase latency and reduce performance of some relatively high priority applications, which may require random accesses or urgent accesses within the folding duration. In the case that each of the block stripe 205-a through the block stripe 205-e may be associated with a VTC 220 indicating a quantity of valid blocks 225, the memory system controller may perform a relatively large quantity of data recovery and fold operations at a high rate, which may be a maximum fold rate supported by the memory system. In some examples, while performing the recovery and fold operations, the memory system controller may ignore (e.g., may not perform operations associated with) incoming accessing commands until the recovery and fold operations are completed, which may increase latency at and reduce performance of the memory system.

As described herein, the memory system controller may dynamically select a fold rate based on a quantity of valid data in the dies 210 when performing recovery and fold operations in order to balance a rate at which the fold operations are performed with the ability for the memory system controller to also perform other access operations while performing the recovery and fold operations. For example, the memory system controller may include a table of mapping information that may map different percentages of a combination (e.g., total, sum) of the VTCs 220 to different candidate fold (e.g., and recovery) rates. In some examples, one or more of the VTCs 220 may indicate (e.g., via a set value) that a quantity of the blocks 225 of respective block stripes 205 are valid (e.g., not be failing). The table may map different combined VTC values to respective fold rates.

As a representative example, if the combination of the VTCs 220 indicates that approximately 25% of the blocks 225 are not associated with an error (e.g., are valid, are unflagged data 230), the mapping information may indicate the fold rate to be one block stripe 205 per two hours, or some other first fold rate. In other examples, if the combination of the VTCs 220 indicates that approximately 40% of the blocks 225 are not associated with an error (e.g., are valid, unflagged data 230), the mapping information may indicate the fold rate to be four block stripes 205 per five hours, or some other second fold rate. If the combination of the VTCs 220 indicates that approximately 50% of the blocks 225 are not associated with an error (e.g., are valid, unflagged data 230), the mapping information may indicate the fold rate to be one block stripe 205 per hour, or some other third fold rate. If the combination of the VTCs 220 indicates that more than 50% of the blocks 225 are not associated with an error (e.g., are valid, unflagged data 230), the mapping information may indicate the fold rate to be two block stripes 205 per hour, or some other fourth fold rate. It is to be understood that the mapping information described may be provided for exemplary purposes, and other mappings of valid data percentages to fold rates may be supported. The mapping information for a given memory system may be determined during manufacture of the memory system, may be set by a user of the memory system, or both.

The memory system controller may select one of the fold rates based on the values of the VTCs 220 and the mapping information, and may begin recovery and fold operations. For example, the memory system controller may select a starting block stripe 205 (e.g., block stripe 205-a) and may initialize a counter associated with the block stripe 205-a. After selecting the block stripe 205 and initializing the counter, the memory system controller may begin the recovery and fold operations according to the selected fold rate. For example, the memory system controller may perform a recovery operation to re-generate the flagged data 235 of the block stripe 205-a using the unflagged data 230 and the parity data 240 of the block stripe 205-a (e.g., in accordance with a RAIN operation, or some other data recovery technique). The memory system controller may transfer the re-generated data, the unflagged data 230, and the parity data 240 from the block stripe 205-a to a block stripe 205 that may not be associated with failing blocks 225 according to the selected fold rate.

In some examples, the memory system controller may adjust the fold rate. For example, while performing the recovery and fold operations, the memory system controller may detect an error in the data being folded from the block stripe 205-c. The memory system controller may increment the value of the counter associated with the block stripe 205-c in response to detecting the error, and may compare the value of the counter to a threshold quantity of errors. In the case that the value of the counter satisfies the threshold quantity, the memory system controller may adjust the selected fold rate to account for the additional errors (e.g., to speed up the folding process).

The memory system controller may continue performing recovery and fold operations on each of the blocks stripes 205 of the architecture 200 according to the selected (e.g., and adjusted) fold rate. In some examples, the memory system controller may perform the recovery and fold operations on a portion of the block stripes 205, on sets of the block stripes 205 within staggered durations of time, and according to other granularities. In some examples, the memory system controller may perform recovery and fold operations on two or more blocks stripes 205 at once.

The memory system controller may perform access operations at the blocks 225 of other block stripes 205 within the dies 210 or within other dies 210 (e.g., not illustrated) while performing the recovery and fold operations. For example, the memory system controller may select a fold rate (e.g., the selected fold rate, the adjusted fold rate) that is less (e.g., slower) than a maximum fold rate supported by the memory system controller. In such cases, the memory system controller may perform operations to access data stored to one or more other block stripes 205 (e.g., in response to various received access commands) during at least a partially overlapping (e.g., consecutive, simultaneous) duration in which the memory system controller performs the recovery and fold operations. For example, the memory system controller may fold one or more portions of the data and may pause the folding intermittently (e.g., periodically, according to one or more defined intervals) to provide time for performing other accesses before resuming the fold.

Use of a dynamic fold rate may increase performance at the memory system while decreasing data loss. For example, rather than being unable to perform operations associated with incoming access operations while performing recovery and folding operations at the block stripes 205, the memory system controller may be able to increase a balance between performing access operations and error correction operations, which may increase efficiency of the memory system. Use of a fold rate based on a quantity of valid blocks 225 within the dies 210 may enable effective die rebuild operations while enabling performance of access operations at least partially overlapping in time, which may decrease latency associated with access operations and decrease data loss associated with recovery operations.

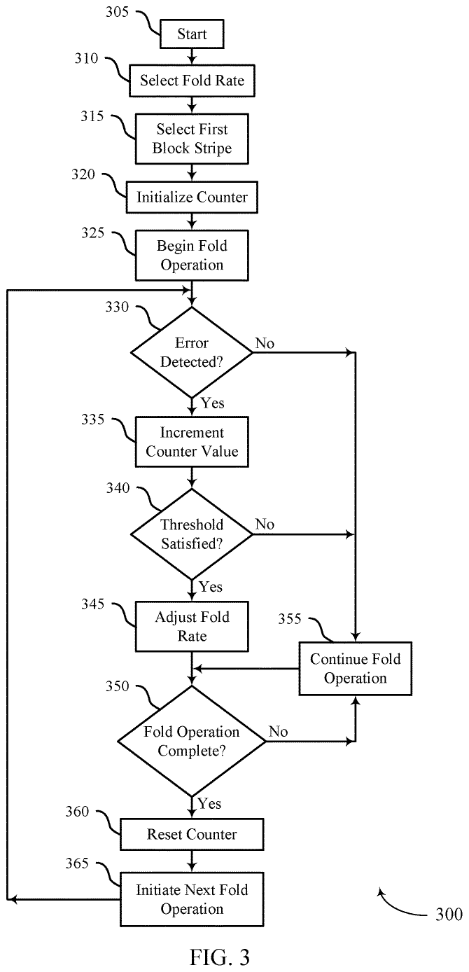

FIG. 3 shows an example of a process 300 that supports die rebuild operations for improved access performance in a memory system in accordance with examples as disclosed herein. The operations of the process 300 may be performed by a memory system or one or more controllers associated with a memory system as described herein. For example, the operations of process 300 may be performed by a memory system 110 or a controller thereof as described with reference to FIG. 1. The process 300 may also include reference to one or more memory dies, memory devices, blocks, and block stripes, which may be examples of memory dies 162, dies 210, blocks 170, blocks 225, and block stripes 205, respectively, as described with reference to FIGS. 1 and 2.

In the following description of the process 300, the operations may be performed in a different order than the order shown, or other operations may be added or removed from the process 300. For example, some operations may be left out of the process 300, may be performed in different orders or at different times, or other operations may be added to the process 300. Although a memory system is described as performing the process 300, some aspects of some operations may also be performed by one or more other memory systems, memory devices, host devices, BMCs, controllers, or other electronic devices (e.g., as described herein with respect to FIGS. 1 and 2).

At 305, a memory system controller may begin memory die rebuild and fold operations, as described herein. The memory system controller may detect a memory die failure. For example, the memory system controller may determine that a memory die of the memory system may have failed (e.g., may be unresponsive or otherwise inaccessible). In response to detecting the die failure, the memory system controller may determine what percentage of the data stored to the memory die, or multiple (e.g., all) memory dies in the memory system is valid data. For example, the memory system controller may determine a ratio of valid data to invalid data stored to the memory system.

At 310, the memory system controller may select a fold rate. For example, the memory system controller may select a fold rate from multiple candidate fold rates based on fold rate mapping information. Each fold rate may be an example of a rate at which the memory system controller may recover data stored to a block stripe associated with a failing memory die and transfer the recovered data to one or more block stripes associated with valid (e.g., not failing) memory dies during a duration. The memory system controller may select the fold rate (e.g., a quantity of folds to perform during a duration) according to mapping information stored to a table of the memory system controller. The mapping information may map amounts of valid data stored to the memory dies to respective candidate fold rates, as described with further detail elsewhere herein, including with reference to FIG. 2. The memory system controller may select the fold rate according to the determined percentage of valid data stored to the memory system. In some examples, a low quantity of valid data may be mapped to a low fold rate, while a high quantity of valid data may be mapped to a high fold rate. For example, if the memory system has less valid data to fold, the memory system may slow fold operations and prioritize other access, which may decrease latency and improve performance.

At 315, the memory system controller may select one or more first block stripes. For example, in response to selecting the fold rate, the memory system controller may select a first block stripe to begin fold operations. The first block stripe may be an example of a starting (e.g., target) block stripe of a quantity of block stripes associated with one or more memory dies of the memory system. Each block stripe may be associated with one or more memory blocks and may span across a quantity of memory dies (e.g., LUNs) of the memory system, as described with reference to FIG. 2. Each block stripe (e.g., the memory blocks thereof) may store data and associated parity data to be used in recovery of the stored data. In some examples, each block stripe may be associated with a counter.

At 320, the memory system controller may initialize a counter associated with the first block stripe. For example, based on selecting the first block stripe, the memory system controller may initialize the counter associated with the first block stripe. To initialize the counter, the memory system controller may reset (e.g., set) the value of the counter to “0,” which may indicate that the memory system controller has not yet detected an error in the rebuilt data of the first block stripe or any errors associated with rebuilding the data of the first block stripe.

At 325, the memory system controller may begin a fold operation. The memory system controller may initiate a fold operation on the first block stripe to recover data from the first block stripe and transfer the recovered data to a second block stripe that is associated with valid (e.g., not failing) memory dies or memory dies associated with less errors. For example, the memory system controller may recover data stored to the first block according to a data recovery operation. In some examples, the memory system controller may determine that one or more portions of the data associated with the first block stripe is stored to the failing memory die (e.g., or to the multiple failing memory dies). The memory system controller may re-generate the portion of the data associated with the failing memory die using the parity and the remaining portions of data stored to the first block stripe. In response to recovering the portion of the data, the memory system controller may transfer the data from the first block stripe to the second block stripe. The memory system controller may transfer the data to the second block stripe according to the selected fold rate and based on re-generating the one or more portions of data associated with the failing memory die.

In some examples, the memory system controller may perform an access operation at another block stripe during a duration that at least partially overlaps with the duration associated with the fold operation. For example, while performing the fold operation, the memory system may receive a command to perform an access operation at a memory die. If the selected fold rate is less than a maximum possible fold rate of the memory system, the memory system controller may perform access operations associated with the received command at block stripes associated with valid memory dies of the memory system while performing the fold operation.

At 330, the memory system controller may determine whether an error is included in the data of the first block stripe. For example, while performing the fold operation, the memory system controller may perform error check operations to determine whether the re-generated data (e.g., and the remaining portions of data) being transferred from the first block stripe to the second block stripe includes one or more errors, whether any errors occurred during the transfer or due to the transfer, or both. If the memory system controller does not detect an error while performing the fold operation, the memory system controller may continue the fold operation at 355 according to the selected fold rate. If the memory system controller does detect an error while performing the fold operation, the memory system controller may increment the value of the counter associated with the first block stripe at 335.

At 335, the memory system controller may increment the value of the counter associated with the first block stripe. For example, in response to detecting an error in the data being folded from the first block stripe during the fold operation, the memory system may increment the value of the counter associated with the first block stripe by one unit (e.g., by 1). The value of the counter may indicate a quantity of errors detected in re-generated data, data to be folded, or any combination thereof.

At 340, the memory system controller may determine whether a threshold value has been satisfied. For example, after incrementing the value of the counter, the memory system controller may determine whether the value of the counter satisfies a threshold value. In some examples, the threshold value may be example of a quantity of errors included in the data that may be allowed prior to increasing a rate at which the folding is performed in order to reduce a likelihood of further potential errors and failure of the folding operation. To determine whether the value of the counter satisfies the threshold value, the memory system controller may compare the value of the counter to the threshold value. If the value of the counter fails to satisfy (e.g., is smaller than) the threshold value, the memory system controller may continue the fold operation at 355 according to the selected fold rate. If the value of the counter satisfies (e.g., is greater than or equal to) the threshold value, the memory system controller may adjust the fold rate at 345.

At 345, the memory system controller may adjust the fold rate. For example, based on determining the value of the counter to satisfy the threshold value, the memory system controller may adjust the fold rate at which to perform the fold operation. In some examples, the memory system controller may adjust the fold rate from the previously selected fold rate (e.g., based on the valid data) to a default fold rate for the memory system. The default fold rate may, in some examples, be a maximum fold rate supported by the memory system, or may otherwise be a relatively high fold rate to ensure that the fold operation is completed as soon as possible, regardless of whether other accesses are able to be executed before the completion or not.

At 350, the memory system controller may determine whether the fold operation is complete. In response to adjusting the fold rate at 345, or continuing the fold operation without a rate adjustment at 355, the memory system controller may determine whether the fold operation (e.g., folding data from the first block stripe to the second block stripe) is complete. If the memory system controller determines the fold operation is not complete, the memory system controller may continue the fold operation at 355 according to the fold rate used prior to 350 (e.g., either the adjusted fold rate or the original fold rate). If the memory system controller determines the fold operation is complete, the memory system controller may reset the value of the counter associated with the first block stripe at 360.

At 355, the memory system controller may continue the fold operation. For example, in response to not detecting an error in the data of the first data stripe while performing the fold operation (e.g., 330), the memory system controller may continue the fold operation according to the selected fold rate. In other examples, in response to determining that the value of the counter fails to satisfy (e.g., is smaller than) the threshold value (e.g., at 340), the memory system controller may continue the fold operation according to the selected fold rate. In other examples, in response to determining the fold operation to be incomplete (e.g., at 350), the memory system controller may continue the fold operation according to the adjusted fold rate (e.g., the default fold rate) or the selected fold rate. Continuing the fold operation may include the memory system controller folding remaining data from the first block stripe to the second block stripe.

At 360, the memory system controller may reset the value of the counter associated with the first block stripe. In response to determining the fold operation is complete, the memory system controller may reset the value of the counter associated with the first block stripe. For example, the memory system controller may set the value of the counter to “0.”

At 365, the memory system controller may initiate the next fold operation. In response to completing the fold operation to re-generate portions of data stored to the first block stripe and to transfer data from the first block stripe to the second block stripe, and in response to resetting the value of the counter associated with the first block stripe, the memory system controller may initiate a next fold operation. In some examples, the memory system controller may increment (e.g., move) a pointer to a next block stripe associated with the failing memory die to be folded. The memory system controller may perform the operations illustrated in FIG. 3 for one or more other block stripes (e.g., may perform one or more other fold operations). While the memory system controller is described herein with reference to FIG. 3 as performing a fold operation on a single block stripe at a time, the memory system controller may also perform fold operations on two or more block stripes during each fold operation, or according to some other granularity.

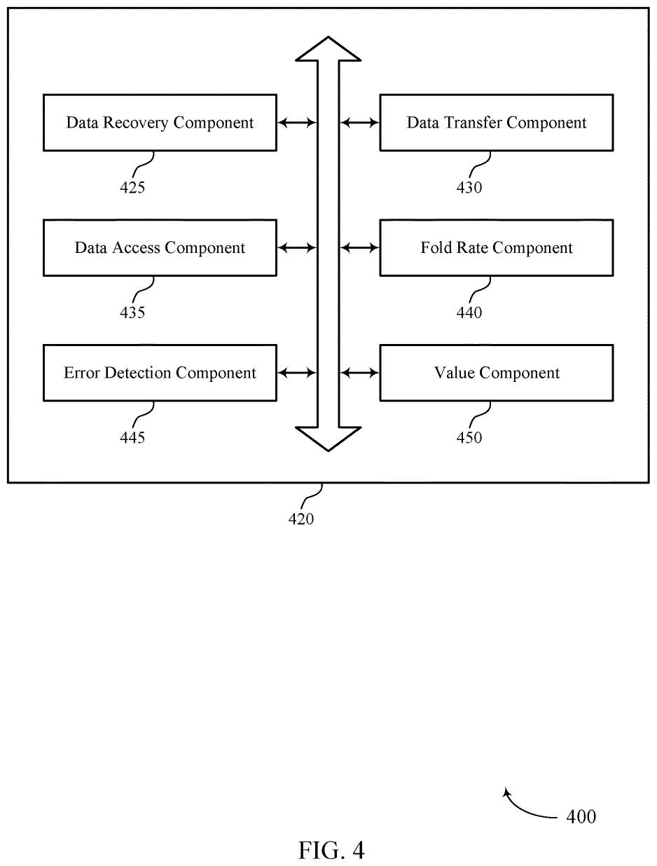

FIG. 4 shows a block diagram 400 of a memory system 420 that supports die rebuild operations for improved access performance in a memory system in accordance with examples as disclosed herein. The memory system 420 may be an example of aspects of a memory system as described with reference to FIGS. 1 through 3. The memory system 420, or various components thereof, may be an example of means for performing various aspects of die rebuild operations for improved access performance in a memory system as described herein. For example, the memory system 420 may include a data recovery component 425, a data transfer component 430, a data access component 435, a fold rate component 440, an error detection component 445, a value component 450, or any combination thereof. Each of these components, or components of subcomponents thereof (e.g., one or more processors, one or more memories), may communicate, directly or indirectly, with one another (e.g., via one or more buses).

The data recovery component 425 may be configured as or otherwise support a means for recovering, in accordance with a data recovery operation of the memory system and based at least in part on a die failure of at least one memory device of a plurality of memory devices, data stored to one or more first block stripes associated with the at least one memory device, where each first block stripe of the one or more first block stripes includes the data and parity data for recovery of the data after the die failure. The data transfer component 430 may be configured as or otherwise support a means for transferring, in accordance with a fold rate, the recovered data from the one or more first block stripes to one or more second block stripes within one or more second memory devices of the plurality of memory devices of the memory system, where the fold rate includes a rate at which the data is recovered and transferred from the one or more first block stripes to the one or more second block stripes during a first duration, and where the fold rate is based at least in part on an amount of valid data included in the memory system. The data access component 435 may be configured as or otherwise support a means for accessing, during a second duration that at least partially overlaps in time with the first duration, second data stored in the plurality of memory devices of the memory system.

In some examples, accessing the second data is based at least in part on the fold rate being less than a maximum fold rate of the memory system.

In some examples, to support recovering the data, the data recovery component 425 may be configured as or otherwise support a means for re-generating, based at least in part on determining that a portion of the data in the one or more first block stripes is stored to the at least one memory device that failed, the portion of the data in accordance with remaining data in the one or more first block stripes and the parity data in the one or more first block stripes, where transferring the data from the one or more first block stripes to the one or more second block stripes is based at least in part on re-generating the portion of the data.

In some examples, the fold rate component 440 may be configured as or otherwise support a means for selecting, from a plurality of candidate fold rates supported by the memory system and in accordance with a tuning operation, the fold rate based at least in part on mapping information that maps the amount of valid data in the memory system to the fold rate, where the mapping information maps other fold rates of the plurality of candidate fold rates to other candidate amounts of valid data in the memory system, and where transferring the data is based at least in part on selecting the fold rate.

In some examples, the error detection component 445 may be configured as or otherwise support a means for detecting, while transferring a portion of the data from a first block stripe of the one or more first block stripes to a second block stripe of the one or more second block stripes, an error associated with the portion of the data. In some examples, the value component 450 may be configured as or otherwise support a means for incrementing, based at least in part on detecting the error, a value of a first counter associated with the first block stripe.

In some examples, the value component 450 may be configured as or otherwise support a means for comparing, based at least in part on incrementing the value of the first counter, the value of the first counter to a threshold quantity of errors. In some examples, the data transfer component 430 may be configured as or otherwise support a means for transferring, based at least in part on the value of the first counter being less than the threshold quantity of errors, the portion of the data and one or more remaining portions of the data from the one or more first block stripes to the one or more second block stripes in accordance with the fold rate.

In some examples, the value component 450 may be configured as or otherwise support a means for comparing, based at least in part on incrementing the value of the first counter, the value of the first counter to a threshold quantity of errors. In some examples, the fold rate component 440 may be configured as or otherwise support a means for adjusting, based at least in part on the value of the first counter being greater than or equal to the threshold quantity of errors, the fold rate to a default fold rate for the memory system. In some examples, the data transfer component 430 may be configured as or otherwise support a means for transferring, based at least in part on adjusting to the default fold rate, the portion of the data and one or more remaining portions of the data from the one or more first block stripes to the one or more second block stripes in accordance with the default fold rate.

In some examples, the value component 450 may be configured as or otherwise support a means for reset, after folding the data from the first block stripe of the one or more first block stripes to the one or more second block stripes, the value of the first counter.

In some examples, the error detection component 445 may be configured as or otherwise support a means for detecting the die failure. In some examples, the error detection component 445 may be configured as or otherwise support a means for determining, in response to detecting the die failure, a percentage of the data that includes valid data, where the fold rate for recovering and transferring the data is based at least in part on determining the percentage of the data that includes the valid data.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

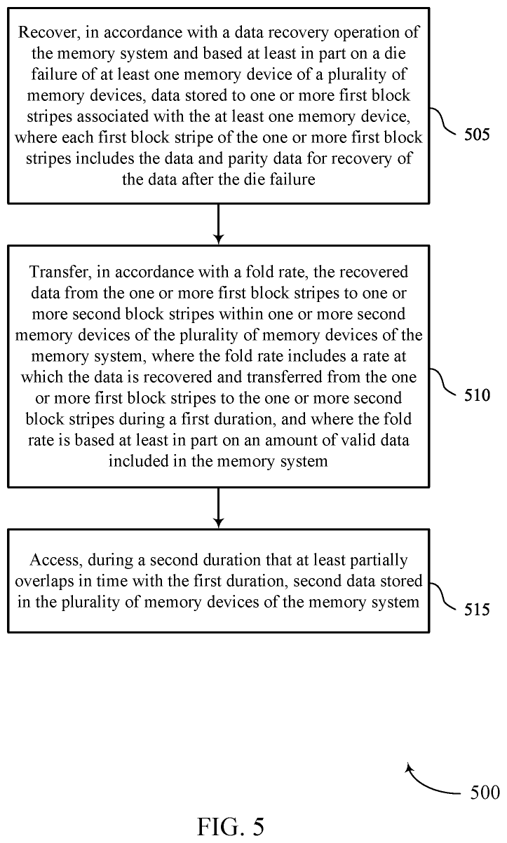

FIG. 5 shows a flowchart illustrating a method 500 that supports die rebuild operations for improved access performance in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include recovering, in accordance with a data recovery operation of the memory system and based at least in part on a die failure of at least one memory device of a plurality of memory devices, data stored to one or more first block stripes associated with the at least one memory device, where each first block stripe of the one or more first block stripes includes the data and parity data for recovery of the data after the die failure. In some examples, aspects of the operations of 505 may be performed by a data recovery component 425 as described with reference to FIG. 4.

At 510, the method may include transferring, in accordance with a fold rate, the recovered data from the one or more first block stripes to one or more second block stripes within one or more second memory devices of the plurality of memory devices of the memory system, where the fold rate includes a rate at which the data is recovered and transferred from the one or more first block stripes to the one or more second block stripes during a first duration, and where the fold rate is based at least in part on an amount of valid data included in the memory system. In some examples, aspects of the operations of 510 may be performed by a data transfer component 430 as described with reference to FIG. 4.

At 515, the method may include accessing, during a second duration that at least partially overlaps in time with the first duration, second data stored in the plurality of memory devices of the memory system. In some examples, aspects of the operations of 515 may be performed by a data access component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for recovering, in accordance with a data recovery operation of the memory system and based at least in part on a die failure of at least one memory device of a plurality of memory devices, data stored to one or more first block stripes associated with the at least one memory device, where each first block stripe of the one or more first block stripes includes the data and parity data for recovery of the data after the die failure; transferring, in accordance with a fold rate, the recovered data from the one or more first block stripes to one or more second block stripes within one or more second memory devices of the plurality of memory devices of the memory system, where the fold rate includes a rate at which the data is recovered and transferred from the one or more first block stripes to the one or more second block stripes during a first duration, and where the fold rate is based at least in part on an amount of valid data included in the memory system; and accessing, during a second duration that at least partially overlaps in time with the first duration, second data stored in the plurality of memory devices of the memory system.

Aspect 2: The method, apparatus, or non-transitory computer-readable medium of aspect 1, where accessing the second data is based at least in part on the fold rate being less than a maximum fold rate of the memory system.

Aspect 3: The method, apparatus, or non-transitory computer-readable medium of any of aspects 1 through 2, where recovering the data includes operations, features, circuitry, logic, means, or instructions, or any combination thereof for re-generating, based at least in part on determining that a portion of the data in the one or more first block stripes is stored to the at least one memory device that failed, the portion of the data in accordance with remaining data in the one or more first block stripes and the parity data in the one or more first block stripes, where transferring the data from the one or more first block stripes to the one or more second block stripes is based at least in part on re-generating the portion of the data.

Aspect 4: The method, apparatus, or non-transitory computer-readable medium of any of aspects 1 through 3, further including operations, features, circuitry, logic, means, or instructions, or any combination thereof for selecting, from a plurality of candidate fold rates supported by the memory system and in accordance with a tuning operation, the fold rate based at least in part on mapping information that maps the amount of valid data in the memory system to the fold rate, where the mapping information maps other fold rates of the plurality of candidate fold rates to other candidate amounts of valid data in the memory system, and where transferring the data is based at least in part on selecting the fold rate.

Aspect 5: The method, apparatus, or non-transitory computer-readable medium of any of aspects 1 through 4, further including operations, features, circuitry, logic, means, or instructions, or any combination thereof for detecting, while transferring a portion of the data from a first block stripe of the one or more first block stripes to a second block stripe of the one or more second block stripes, an error associated with the portion of the data and incrementing, based at least in part on detecting the error, a value of a first counter associated with the first block stripe.

Aspect 6: The method, apparatus, or non-transitory computer-readable medium of aspect 5, further including operations, features, circuitry, logic, means, or instructions, or any combination thereof for comparing, based at least in part on incrementing the value of the first counter, the value of the first counter to a threshold quantity of errors and transferring, based at least in part on the value of the first counter being less than the threshold quantity of errors, the portion of the data and one or more remaining portions of the data from the one or more first block stripes to the one or more second block stripes in accordance with the fold rate.

Aspect 7: The method, apparatus, or non-transitory computer-readable medium of any of aspects 5 through 6, further including operations, features, circuitry, logic, means, or instructions, or any combination thereof for comparing, based at least in part on incrementing the value of the first counter, the value of the first counter to a threshold quantity of errors; adjusting, based at least in part on the value of the first counter being greater than or equal to the threshold quantity of errors, the fold rate to a default fold rate for the memory system; and transferring, based at least in part on adjusting to the default fold rate, the portion of the data and one or more remaining portions of the data from the one or more first block stripes to the one or more second block stripes in accordance with the default fold rate.

Aspect 8: The method, apparatus, or non-transitory computer-readable medium of any of aspects 5 through 7, further including operations, features, circuitry, logic, means, or instructions, or any combination thereof for reset, after folding the data from the first block stripe of the one or more first block stripes to the one or more second block stripes, the value of the first counter.

Aspect 9: The method, apparatus, or non-transitory computer-readable medium of any of aspects 1 through 8, further including operations, features, circuitry, logic, means, or instructions, or any combination thereof for detecting the die failure and determining, in response to detecting the die failure, a percentage of the data that includes valid data, where the fold rate for recovering and transferring the data is based at least in part on determining the percentage of the data that includes the valid data.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
recover, in accordance with a data recovery operation of the memory system and based at least in part on a die failure of at least one memory device of a plurality of memory devices, data stored to one or more first block stripes associated with the at least one memory device, wherein each first block stripe of the one or more first block stripes comprises the data and parity data for recovery of the data after the die failure;
transfer, in accordance with a fold rate, the recovered data from the one or more first block stripes to one or more second block stripes within one or more second memory devices of the plurality of memory devices of the memory system, wherein the fold rate comprises a rate at which the data is recovered and transferred from the one or more first block stripes to the one or more second block stripes during a first duration, and wherein the fold rate is based at least in part on an amount of valid data included in the memory system; and
access, during a second duration that at least partially overlaps in time with the first duration, second data stored in the plurality of memory devices of the memory system.

2. The memory system of claim 1, wherein accessing the second data is based at least in part on the fold rate being less than a maximum fold rate of the memory system.

3. The memory system of claim 1, wherein recovering the data comprises the processing circuitry configured to cause the memory system to:
re-generate, based at least in part on determining that a portion of the data in the one or more first block stripes is stored to the at least one memory device that failed, the portion of the data in accordance with remaining data in the one or more first block stripes and the parity data in the one or more first block stripes, wherein transferring the data from the one or more first block stripes to the one or more second block stripes is based at least in part on re-generating the portion of the data.

4. The memory system of claim 1, wherein the processing circuitry is further configured to cause the memory system to:
select, from a plurality of candidate fold rates supported by the memory system and in accordance with a tuning operation, the fold rate based at least in part on mapping information that maps the amount of valid data in the memory system to the fold rate, wherein the mapping information maps other fold rates of the plurality of candidate fold rates to other candidate amounts of valid data in the memory system, and wherein transferring the data is based at least in part on selecting the fold rate.

5. The memory system of claim 1, wherein the processing circuitry is further configured to cause the memory system to:
detect, while transferring a portion of the data from a first block stripe of the one or more first block stripes to a second block stripe of the one or more second block stripes, an error associated with the portion of the data; and
increment, based at least in part on detecting the error, a value of a first counter associated with the first block stripe.

6. The memory system of claim 5, wherein the processing circuitry is further configured to cause the memory system to:
compare, based at least in part on incrementing the value of the first counter, the value of the first counter to a threshold quantity of errors; and
transfer, based at least in part on the value of the first counter being less than the threshold quantity of errors, the portion of the data and one or more remaining portions of the data from the one or more first block stripes to the one or more second block stripes in accordance with the fold rate.

7. The memory system of claim 5, wherein the processing circuitry is further configured to cause the memory system to:
compare, based at least in part on incrementing the value of the first counter, the value of the first counter to a threshold quantity of errors;
adjust, based at least in part on the value of the first counter being greater than or equal to the threshold quantity of errors, the fold rate to a default fold rate for the memory system; and
transfer, based at least in part on adjusting to the default fold rate, the portion of the data and one or more remaining portions of the data from the one or more first block stripes to the one or more second block stripes in accordance with the default fold rate.

8. The memory system of claim 5, wherein the processing circuitry is further configured to cause the memory system to:
reset, after folding the data from the first block stripe of the one or more first block stripes to the one or more second block stripes, the value of the first counter.

9. The memory system of claim 1, wherein the processing circuitry is further configured to cause the memory system to:
detect the die failure; and
determine, in response to detecting the die failure, a percentage of the data that comprises valid data, wherein the fold rate for recovering and transferring the data is based at least in part on determining the percentage of the data that comprises the valid data.

10. A method at a memory system, comprising:
recovering, in accordance with a data recovery operation of the memory system and based at least in part on a die failure of at least one memory device of a plurality of memory devices, data stored to one or more first block stripes associated with the at least one memory device, wherein each first block stripe of the one or more first block stripes comprises the data and parity data for recovery of the data after the die failure;
transferring, in accordance with a fold rate, the recovered data from the one or more first block stripes to one or more second block stripes within one or more second memory devices of the plurality of memory devices of the memory system, wherein the fold rate comprises a rate at which the data is recovered and transferred from the one or more first block stripes to the one or more second block stripes during a first duration, and wherein the fold rate is based at least in part on an amount of valid data included in the memory system; and
accessing, during a second duration that at least partially overlaps in time with the first duration, second data stored in the plurality of memory devices of the memory system.

11. The method of claim 10, wherein accessing the second data is based at least in part on the fold rate being less than a maximum fold rate of the memory system.

12. The method of claim 10, wherein recovering the data comprises:
re-generating, based at least in part on determining that a portion of the data in the one or more first block stripes is stored to the at least one memory device that failed, the portion of the data in accordance with remaining data in the one or more first block stripes and the parity data in the one or more first block stripes, wherein transferring the data from the one or more first block stripes to the one or more second block stripes is based at least in part on re-generating the portion of the data.

13. The method of claim 10, further comprising:
selecting, from a plurality of candidate fold rates supported by the memory system and in accordance with a tuning operation, the fold rate based at least in part on mapping information that maps the amount of valid data in the memory system to the fold rate, wherein the mapping information maps other fold rates of the plurality of candidate fold rates to other candidate amounts of valid data in the memory system, and wherein transferring the data is based at least in part on selecting the fold rate.

14. The method of claim 10, further comprising:
detecting, while transferring a portion of the data from a first block stripe of the one or more first block stripes to a second block stripe of the one or more second block stripes, an error associated with the portion of the data; and
incrementing, based at least in part on detecting the error, a value of a first counter associated with the first block stripe.

15. The method of claim 14, further comprising:
comparing, based at least in part on incrementing the value of the first counter, the value of the first counter to a threshold quantity of errors; and
transferring, based at least in part on the value of the first counter being less than the threshold quantity of errors, the portion of the data and one or more remaining portions of the data from the one or more first block stripes to the one or more second block stripes in accordance with the fold rate.

16. The method of claim 14, further comprising:
comparing, based at least in part on incrementing the value of the first counter, the value of the first counter to a threshold quantity of errors;
adjusting, based at least in part on the value of the first counter being greater than or equal to the threshold quantity of errors, the fold rate to a default fold rate for the memory system; and
transferring, based at least in part on adjusting to the default fold rate, the portion of the data and one or more remaining portions of the data from the one or more first block stripes to the one or more second block stripes in accordance with the default fold rate.

17. The method of claim 14, further comprising:
resetting, after folding the data from the first block stripe of the one or more first block stripes to the one or more second block stripes, the value of the first counter.

18. The method of claim 10, further comprising:
detecting the die failure; and
determining, in response to detecting the die failure, a percentage of the data that comprises valid data, wherein the fold rate for recovering and transferring the data is based at least in part on determining the percentage of the data that comprises the valid data.

19. A non-transitory computer-readable medium storing code, the code comprising instructions executable by one or more processors to:
recover, in accordance with a data recovery operation of a memory system and based at least in part on a die failure of at least one memory device of a plurality of memory devices, data stored to one or more first block stripes associated with the at least one memory device, wherein each first block stripe of the one or more first block stripes comprises the data and parity data for recovery of the data after the die failure;
transfer, in accordance with a fold rate, the recovered data from the one or more first block stripes to one or more second block stripes within one or more second memory devices of the plurality of memory devices of the memory system, wherein the fold rate comprises a rate at which the data is recovered and transferred from the one or more first block stripes to the one or more second block stripes during a first duration, and wherein the fold rate is based at least in part on an amount of valid data included in the memory system; and
access, during a second duration that at least partially overlaps in time with the first duration, second data stored in the plurality of memory devices of the memory system.

20. The non-transitory computer-readable medium of claim 19, wherein accessing the second data is based at least in part on the fold rate being less than a maximum fold rate of the memory system.

21. The non-transitory computer-readable medium of claim 19, wherein the instructions to recover the data are executable by the one or more processors to:
re-generate, based at least in part on determining that a portion of the data in the one or more first block stripes is stored to the at least one memory device that failed, the portion of the data in accordance with remaining data in the one or more first block stripes and the parity data in the one or more first block stripes, wherein transferring the data from the one or more first block stripes to the one or more second block stripes is based at least in part on re-generating the portion of the data.

22. The non-transitory computer-readable medium of claim 19, wherein the instructions are further executable by the one or more processors to:
select, from a plurality of candidate fold rates supported by the memory system and in accordance with a tuning operation, the fold rate based at least in part on mapping information that maps the amount of valid data in the memory system to the fold rate, wherein the mapping information maps other fold rates of the plurality of candidate fold rates to other candidate amounts of valid data in the memory system, and wherein transferring the data is based at least in part on selecting the fold rate.

23. The non-transitory computer-readable medium of claim 19, wherein the instructions are further executable by the one or more processors to:
detect, while transferring a portion of the data from a first block stripe of the one or more first block stripes to a second block stripe of the one or more second block stripes, an error associated with the portion of the data; and
increment, based at least in part on detecting the error, a value of a first counter associated with the first block stripe.

24. The non-transitory computer-readable medium of claim 23, wherein the instructions are further executable by the one or more processors to:
compare, based at least in part on incrementing the value of the first counter, the value of the first counter to a threshold quantity of errors; and
transfer, based at least in part on the value of the first counter being less than the threshold quantity of errors, the portion of the data and one or more remaining portions of the data from the one or more first block stripes to the one or more second block stripes in accordance with the fold rate.

25. The non-transitory computer-readable medium of claim 23, wherein the instructions are further executable by the one or more processors to:
compare, based at least in part on incrementing the value of the first counter, the value of the first counter to a threshold quantity of errors;
adjust, based at least in part on the value of the first counter being greater than or equal to the threshold quantity of errors, the fold rate to a default fold rate for the memory system; and
transfer, based at least in part on adjusting to the default fold rate, the portion of the data and one or more remaining portions of the data from the one or more first block stripes to the one or more second block stripes in accordance with the default fold rate.
